(19) United States
(12) Patent Application Publication
(10) Pub. No.: US 2012/0054360 A1
(43) Pub. Date: Mar. 1, 2012

(54) COMMUNICATION DEVICE AND COMMUNICATION SYSTEM THEREOF

(75) Inventor: Chung-Chiu Lai, Hsinchu County (TW)

(73) Assignee: GEMTEK TECHNOLOGY CO., LTD., Hsinchu (TW)

(21) Appl. No.: 12/869,752

(22) Filed: Aug. 27, 2010

(51) Int. Cl. G06F 15/16

(52) U.S. Cl. 709/230; 709/246

(57) ABSTRACT

A communication device and a communication system are provided. The communication device is adapted for transmitting and receiving IP packets over a physical signal link with a network medium, and includes an electronic device and a transceiver device. The electronic device transmits a first IP packet and receives a second IP packet, and includes a first physical data interface for transmitting first physical data converted from the first IP packet and receiving second physical data to be converted to the second IP packet. The transceiver device is coupled to the electronic device through the first physical data interface, and transmits the first physical data to the physical signal link and receiving the second physical data from the physical signal link, where the transceiver device establishes the physical signal link with the receiver without dialing.

### BACKGROUND

1. Technical Field

The invention generally relates to a communication apparatus, and more particularly, to a communication device transmitting and receiving Internet Protocol packet over a physical signal link without a network medium and a communication system thereof.

2. Related Art

Although broadband data communication technology has been developed for many years and widely penetrate into our daily lives these days, there are still some industries and application areas which require merely low cost but stable data communication. Namely, there are, for example, electric meters, water meters, gas meters and public transport ticket check points and so fourth. Currently, these applications or devices as mentioned above mostly support low cost serial port interface such as RS-232 standard, or low cost parallel port interface such as parallel printer port. Another advantage of such low cost serial port interface or low cost parallel port interface is simple implementation of signal transmission.

However, the above-described low cost serial port interface and low cost parallel port interface merely support physical layer data transmission and related control signaling. In other words, the above-described low cost serial port interface and low cost parallel port interface usually do not have network medium and thus do not support higher layer protocol such as Internet Protocol (IP), associated IP packet format and even medium access layer protocol. Therefore, it is a major concern that how to realize a TCP/IP transmission or IP packet delivery on a communication device without a network medium.

### SUMMARY

Accordingly, the invention provides a communication device and a communication system thereof. The communication device and the communication system transmit and receive Internet Protocol (IP) packet over a physical signal link without network medium. The communication device and the communication system realize transmission of IP packet via conventional serial port interface and conventional parallel port interface, which are originally designed without a network medium or IP protocol capability.

In consistent with an exemplary embodiment of the invention, the invention proposes a communication device, adapted for transmitting and receiving IP packets over a physical signal link with a network medium, and the communication device includes an electronic device and a transceiver device. The electronic device transmits a first IP packet and receives a second IP packet, and includes a first physical data interface for transmitting first physical data converted from the first IP packet and receiving second physical data to be converted to the second IP packet. The transceiver device is coupled to the electronic device through the first physical data interface, and transmits the first physical data to the physical signal link and receiving the second physical data from the physical signal link, where the transceiver device establishes the physical signal link with the receiver without dialing.

In consistent with an exemplary embodiment of the invention, the invention proposes communication system, adapted for delivering IP packets over a physical signal link with a network medium. The communication system includes a first communication device and a second communication device. The first communication device is configured for transmitting a first IP packet and receiving a second IP packet, and includes a first physical data interface and a first transceiver device. The first physical data interface is configured for transmitting first physical data converted from the first IP packet and receiving second physical data to be converted to the second IP packet. The first transceiver device is coupled to the first physical data interface through a second physical data interface thereof, and is configured for transmitting the first physical data to the physical signal link and receiving the second physical data from the physical signal link. The second communication device is coupled to the first communication device through the physical signal link and the first transceiver device, wherein the first transceiver device establishes the physical signal link with a second transceiver device of the second communication device without dialing.

It is to be understood that both the foregoing general description and the following detailed description are exemplary, and are further intended to provide the explanation of the present disclosure as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and serve to explain the principles of the invention together with the description.

FIG. 1 is a system block diagram illustrating a communication system utilizing a physical signal link without network medium according to a first exemplary embodiment of the invention.

FIG. 2 is a system block diagram illustrating another communication system utilizing a physical signal link without network medium according to a second exemplary embodiment of the invention.

FIG. 3 is a functional block diagram illustrating an electronic device and a transceiver device realizing an IP packet transmission over a physical signal link without network medium according to the first exemplary embodiment of the invention.

FIG. 4 is a functional block diagram illustrating an electronic device and a transceiver device realizing an IP packet transmission over a physical signal link without network medium according to the second exemplary embodiment of the invention.

FIG. 5 is a flowchart illustrating a method of transmitting and receiving an IP packet over a physical signal link without network medium according to the first exemplary embodiment of the invention.

FIG. 6 is a flowchart illustrating a method of transmitting an IP packet over a physical signal link without network medium according to the second exemplary embodiment of the invention.

FIG. 7 is a flowchart illustrating a method of receiving an IP packet over a physical signal link without network medium according to the second exemplary embodiment of the invention.

FIG. 8 is a flowchart illustrating a method of transmitting an IP packet over a physical signal link without network medium according to a third exemplary embodiment of the invention.

FIG. 9 is a flowchart illustrating another method of transmitting an IP packet over a physical signal link without network medium according to the third exemplary embodiment of the invention.

FIG. 10 is a flowchart illustrating a method of receiving an IP packet over a physical signal link without network medium according to the third exemplary embodiment of the invention.

### DESCRIPTION OF THE EXEMPLARY EMBODIMENTS

Reference will now be made in detail to the exemplary embodiments of the invention, examples of which are illustrated in the accompanying drawings. Wherever possible, the same reference numbers are used in the drawings and the description to refer to the same or like parts.

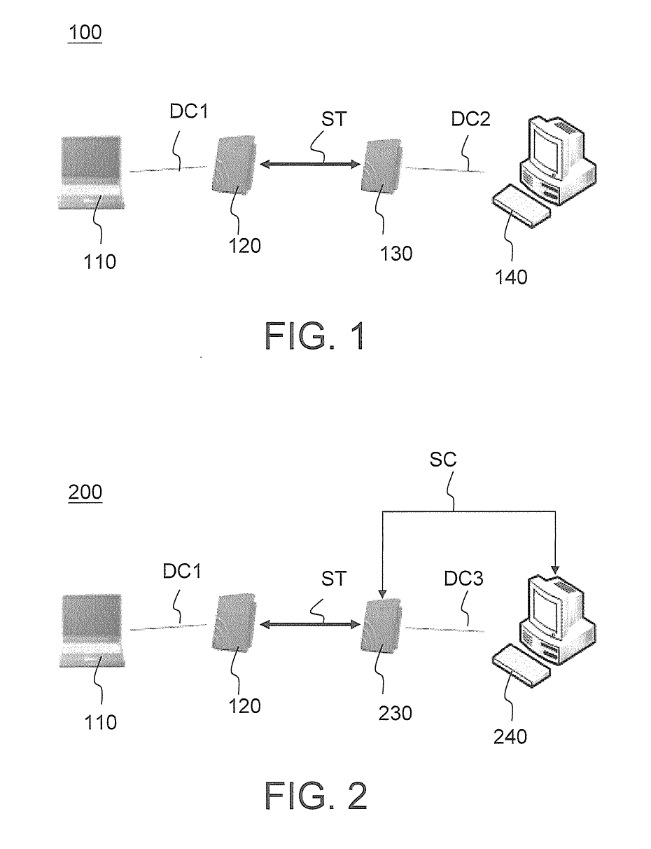

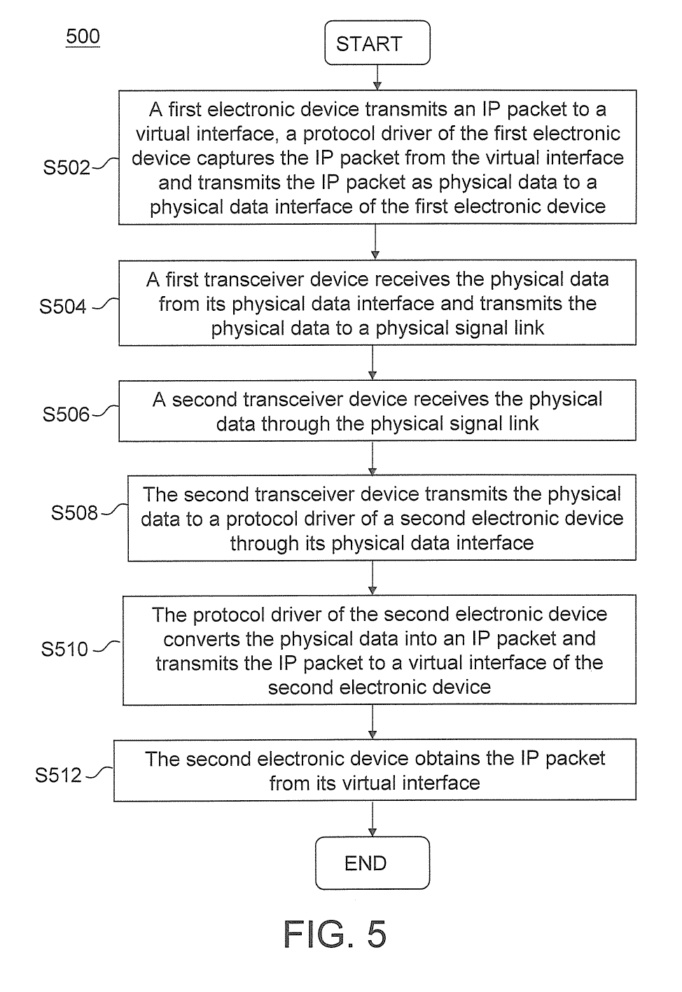

FIG. 1 is a system block diagram illustrating a communication system 100 utilizing a physical signal link without network medium according to a first exemplary embodiment of the invention. The communication system 100 includes an electronic device 110, a transceiver device 120, a transceiver device 130 and an electronic device 140. For example, the communication system 100 can be of a client-server architecture, in which the electronic device 110 is a client device and the electronic device 140 is a server. Also, the electronic device 110 can be an electric meter recording an electricity usage figures and regularly reports the electricity usage figures back to the server (i.e., the electronic device 140). The invention is not limited to the description above; the electronic device 110 can be, for example, a water meter, a gas meter, a public transport ticket check point and so forth. In addition, the detailed operation procedures for transmitting and receiving IP packet over the transceiver device 120 and the transceiver device 130, which are without network medium, will be further described in accordance with FIG. 5.

Since most electric meter is a low cost apparatus, the electric meter or the electronic device 110 is mostly equipped with low cost serial port interface such as RS-232 standard interface or serial port interface (SPI). The electronic device 110 is coupled to the transceiver device 120 through such low cost serial port interface (indicated as a data connection DC1 in FIG. 1). The transceiver device 120 establishes a physical signal link ST with the transceiver device 130 once the transceiver device 120 and the transceiver device 130 are switched on. As long as the transceiver device 120 and the transceiver device 130 are switched on, the physical signal link ST is in operation and the transceiver device 120 and the transceiver device 130 always recognize they are connected with each other through the physical signal link ST.

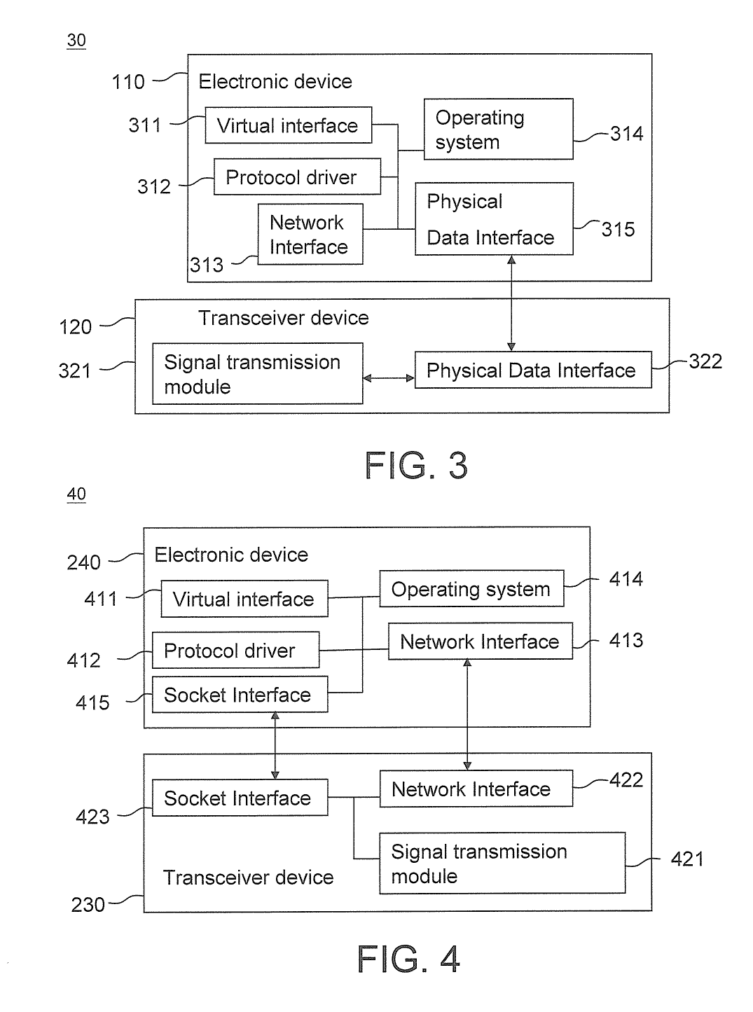

The electronic device 140 is coupled to the transceiver device 130 through similar serial port interface (indicated as a data connection DC2 in FIG. 1). Main functions of the electronic device 110, the transceiver device 120, the transceiver device 130 and the electronic device 140 will be further described in accordance with FIG. 3. In addition, the invention is not limited thereto, and in other embodiments of the invention, the electronic device 110 can be coupled to the transceiver device 120 through a low cost parallel port interface such as printer parallel port. So can be the electronic device 140 coupled to the transceiver device 130 through the low cost parallel port interface.

FIG. 2 is a system block diagram illustrating another communication system 200 utilizing a physical signal link without network medium according to a second exemplary embodiment of the invention. The communication system 200 is similar to the communication system 100 except that the communication system 200 includes a transceiver device 230 and an electronic device 240 being coupled with each other through a standard network interface (indicated as a network connection DC3 in FIG. 2). Alternatively, there is also a socket connection SC established between the transceiver device 230 and the electronic device 240. Main functions of the transceiver device 230 and the electronic device 240 will be further described in accordance with FIG. 4.

FIG. 3 is a functional block diagram illustrating the electronic device 110 and the transceiver device 120 realizing an IP packet transmission over a physical signal link ST without network medium according to the first exemplary embodiment of the invention. Referring to FIG. 3, the electronic device 110 includes a virtual interface 311, a protocol driver 312, a network interface 313, an operating system 314 and a physical data interface 315. The transceiver device 120 includes a signal transmission module 321 and a physical data interface 322. The electronic device 110 is coupled to the transceiver device 120 through the physical data interface 315 and the physical data interface 322, which establish the data connection DC1 as shown in FIG. 1. It is to be noted that, the physical data interface 315 and the physical data interface 322 can be serial port interface or parallel port interface depending upon practical implementations.

The invention is not limited to the first exemplary embodiment, and, in other embodiments of the invention, the electronic device 110 and the transceiver device 120 can be integrated as a communication device 30. In such as case, the electronic device 110 regards the transceiver device 120 merely as a network card or a network port through the protocol driver 312.

In the first exemplary embodiment, the physical signal link ST can be wired communication or wireless communication, can be with or without control signaling, and can be with or without modulation processing. Also, the physical signal link ST does not require dialing to be established between the transceiver device 120 and the transceiver device 130. The physical signal link ST along with the physical data interface 315 and the physical data interface 322 can merely deliver physical layer data but do not have network medium capability such as IP layer capability. Since the physical signal link ST is not a main issue of the invention, the detailed technical operations of the physical signal link ST will not be described herein.

In the electronic device 110, the virtual interface 311, the protocol driver 312, the network interface 313, the operating system 314 and the physical data interface 315 are connected with each other. In the transceiver device 120, the signal transmission module 321 is connected with the physical data interface 322. The electronic device 110 can also include other elements such as application software being operating in the operating system 314 in order to generate, receive and process IP packets. The network interface 313 has a physical network port such as an Ethernet port. Also, the network interface 313 has an associated IP address or a medium access layer address such as a MAC address. The IP packet originated from the electronic device 110 normally can be forwarded to the network interface 313 and further delivered to the destination device. However, since the electronic device 110 is coupled to the transceiver device 120, which is without network medium, there should be other mechanisms implemented in order to transmit the IP packet to the destination device, such as the electronic device 140, over the transceiver device 120 and the physical signal link ST.

In the electronic device 110, the virtual interface 311 can have a different IP address or a different IP domain other than that of the electronic device 110. The virtual interface 311 is substantially different from the network interface 313 since the virtual interface 311 merely has an IP address but does not have a physical network port. Moreover, the operating system 314 uses the protocol driver 312 to capture outgoing IP packets from the virtual interface 311 and transmit incoming IP packets to the virtual interface 311. In the first exemplary embodiment, the electronic device 140 and the transceiver device 130 are respectively similar to the electronic device 110 and the transceiver device 120, so the detailed functions of the electronic device 140 and the transceiver device 130 can be referred to the descriptions in accordance with FIG. 3.

FIG. 4 is a functional block diagram illustrating the electronic device 240 and the transceiver device 230 realizing an IP packet transmission over a physical signal link without network medium according to the second exemplary embodiment of the invention. In the second exemplary embodiment, the electronic device 110 and the transceiver device 130 can be referred to the descriptions in accordance with FIG. 3. The electronic device 240 includes a virtual interface 411, a protocol driver 412, a network interface 413, an operating system 414 and a socket interface 415. The transceiver device 230 includes a signal transmission module 421, a network interface 422 and a socket interface 423. The electronic device 240 is coupled to the transceiver device 230 through the network interface 413 and the network interface 423, which establish the data connection DC3 as shown in FIG. 2. Also, in some cases, the electronic device 240 is coupled to the transceiver device 230 through the socket interface 415 and the socket interface 423 in order to decrypt encrypted packets being transmitted from the transceiver device 230 to the electronic device 240. It is to be noted that the socket interface 415 and the socket interface 423 should be operating upon the TCP/IP connection established between the network interface 413 and the network interface 422. In other words, a socket connection SC is established over the network interface 413 and the network interface 422 as shown in FIG. 4.

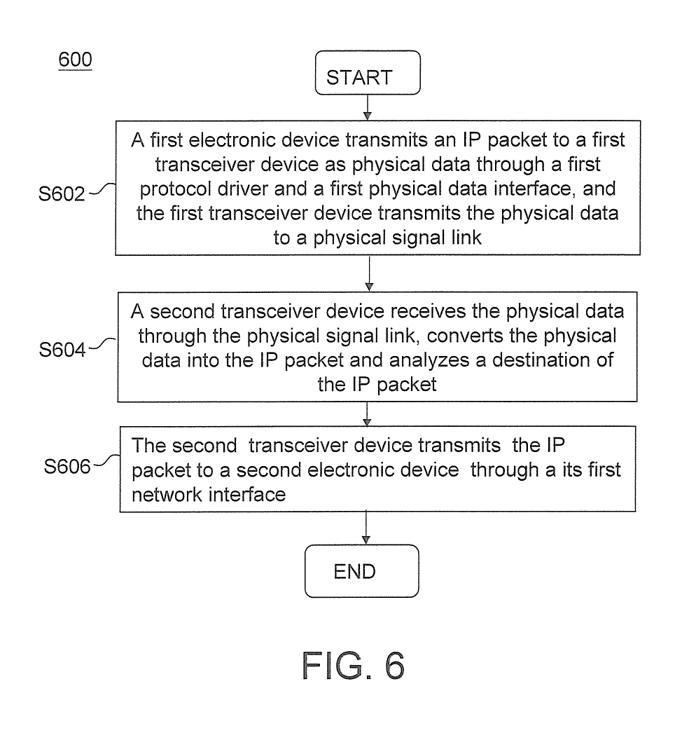

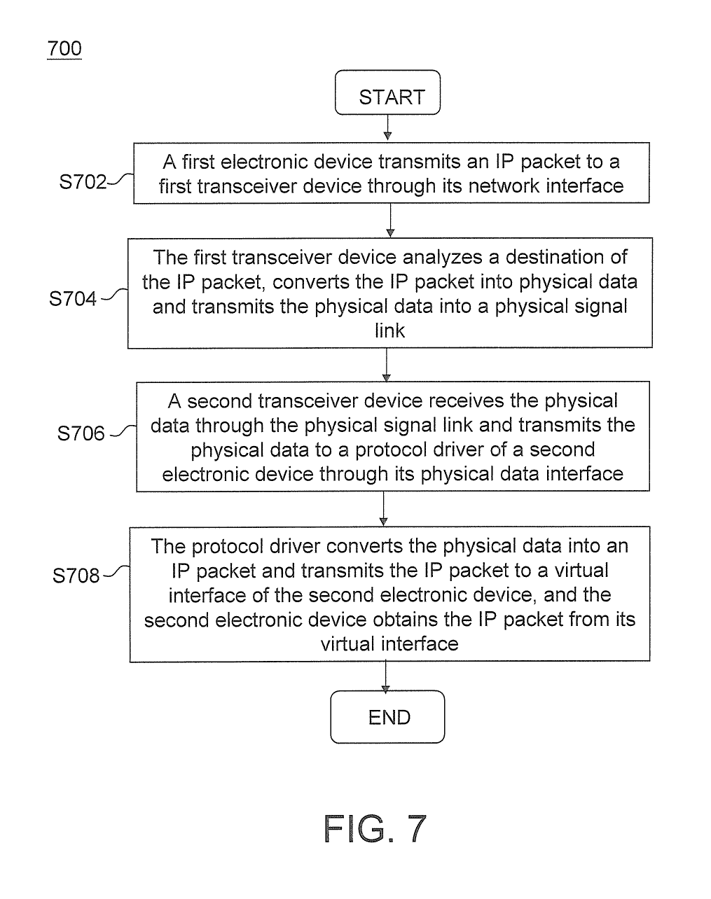

Similar to the electronic device 110, in the electronic device 240, the virtual interface 413 can have a different IP address or a different IP domain other than that of the electronic device 240. The virtual interface 411, the protocol driver 412, the network interface 413, the operating system 414 and the socket interface 415 are connected with each other. Moreover, the virtual interface 411, the protocol driver 412, the network interface 413 and the operating system 414 are respectively similar to the virtual interface 311, the protocol driver 312, the network interface 313 and the operating system 314 of the electronic device 110, so the functions of the elements of the electronic device 240 will not be described in detail herein. The signal transmission module 421, the network interface 422 and the socket interface 423 are connected with each other. Moreover, the signal transmission module 421 and the network interface 422 are respectively similar to the signal transmission module 321 and the network interface 322 of the transceiver device 120. In addition, the detailed operation procedures for transmitting and receiving IP packet from the electronic device 240 to the electronic device 110 over the transceiver device 120 and the transceiver device 230, which are without network medium, will be further described in accordance with FIG. 6 and FIG. 7.

The invention is not limited to the first exemplary embodiment, and, in other embodiments of the invention, the electronic device 240 and the transceiver device 230 can be integrated as a communication device 40. In such as case, the electronic device 240 regards the transceiver device 230 merely as a network card or a network port through the protocol driver 412.

In the second exemplary embodiment, the physical signal link ST may be wired or wireless communication, can be with or without control signaling, and can be with or without modulation processing. Also, dialing is not required for the physical signal link ST to be established between the transceiver device 120 and the transceiver device 230. It is to be noted that the physical signal link ST along with the physical data interface 315 and the physical data interface 322 can merely deliver physical layer data but do not have network medium capability such as IP layer capability. Since the physical signal link ST is not a main issue of the invention, the detailed technical operations of the physical signal link ST will not be described herein.

FIG. 5 is a flowchart illustrating a method of transmitting and receiving an IP packet over a physical signal link without network medium according to the first exemplary embodiment of the invention. Referring to FIG. 1, FIG. 3 and FIG. 5, the method 500 starts at a step S502. In step S502, A first electronic device (such as the electronic device 110) generates an IP packet and then transmits the IP packet to its virtual interface 311. A protocol driver 312 of the first electronic device captures the IP packet from the virtual interface 311 and transmits the IP packet as physical data to a physical data interface 315 of the first electronic device. In step S504, A first transceiver device (such as the transceiver device 120) receives the physical data from its physical data interface 322 and transmits the physical data to a physical signal link ST. In step S506, a second transceiver device (such as the transceiver device 130) receives the physical data through the physical signal link ST.

In step S508, the second transceiver device transmits the physical data to a protocol driver of a second electronic device (such as the protocol driver 412 of the electronic device 140) through its physical data interface (i.e., the physical data interface 322 of the transceiver device 130). In step S510, the protocol driver of the second electronic device converts the physical data into an IP packet and transmits the IP packet to a virtual interface of the second electronic device (i.e., the virtual interface 311 of the electronic device 140). In step S512, the second electronic device obtains the IP packet from its virtual interface (i.e., the virtual interface 311), and processes the IP packet. The method 500 is terminated after the step S512. It is to be noted that the step S508 to the step S512 can also be applied to the electronic device 110 and the transceiver 120 since the communication system 100 is a symmetrical communication system in terms of basic functions for delivering the IP packets.

Referring to FIG. 1, if both the electronic device 110 and the electronic device 140 are both in the same IP domain such that both electronic device 110 and the electronic device 140 do not need the virtual interfaces. On the other hand, the electronic device 110 and the electronic device 140 can be in different IP domains, for example, the electronic device 110 has an IP address of “192.168.1.1” and the electronic device 140 has an IP address of “192.168.2.1”. In such a case, the virtual interface 311 of the electronic device 110 should have a first IP address belonging to the same IP domain as that of the electronic device 140; the virtual interface 411 of the electronic device 140 should have a second IP address belonging to the same IP domain as that of the electronic device 110 such that both the electronic device 110 and the electronic device 140 can easily and smoothly transmit and receive IP packets between each other.

FIG. 6 is a flowchart illustrating a method of transmitting an IP packet over a physical signal link without network medium according to the second exemplary embodiment of the invention. Referring to FIG. 2, FIG. 3, FIG. 4 and FIG. 6, the method 600 starts at a step S602, and the method 600 is an IP packet delivery mechanism in a unidirectional from the electronic device 110 to the electronic device 240. In step S602, a first electronic device (such as the electronic device 110) transmits an IP packet to a first transceiver device (such as the transceiver device 120) as physical data through a first protocol driver (such as the protocol driver 312) and a first physical data interface (such as the physical data interface 315). The first transceiver device (such as the transceiver device 120) transmits the physical data to a physical signal link ST. The step S602 is similar to the step S502 to the step S504.

In step S604, a second transceiver device (such as the transceiver device 230) receives the physical data through the physical signal link ST, converts the physical data into the IP packet and analyzes a destination of the IP packet. In step S606, it is assumed that the IP packet is destined for the electronic device 240 as shown in FIG. 2, so the second transceiver device transmits the IP packet to a second electronic device (such as the electronic device 240) through its first network interface (such as the network interface 422). The method 600 is terminated after the step S606. The mechanism for delivering the IP packet in another direction from the electronic device 240 to the electronic device 110 can be referred to FIG. 7.

FIG. 7 is a flowchart illustrating a method of receiving an IP packet over a physical signal link without network medium according to the second exemplary embodiment of the invention. The term “receiving” is defined with respect to the electronic device 110. Referring to FIG. 2, FIG. 3, FIG. 4 and FIG. 7, the method 700 starts at a step S702. In the step S702, a first electronic device (such as the electronic device 240) transmits an IP packet to a first transceiver device (such as the transceiver device 230) through its network interface (such as the network interface 413). In the step S704, the first transceiver device analyzes a destination of the IP packet, converts the IP packet into physical data and transmits the physical data into a physical signal link ST.

It is assumed that the IP packet is destined for the electronic device 110 as shown in FIG. 2. Thus, in step S706, a second transceiver device (such as the transceiver device 120) receives the physical data through the physical signal link ST and transmits the physical data to a protocol driver of a second electronic device (i.e., the protocol driver 312 of the electronic device 110) through its physical data interface (such as the physical data interface 322). In step S708, the protocol driver (i.e., the protocol driver 312) converts the physical data into an IP packet and transmits the IP packet to a virtual interface of the second electronic device (e.g., the virtual interface 311 of the electronic device 110), and the second electronic device obtains the IP packet from its virtual interface. The method 700 is terminated after the step S708.

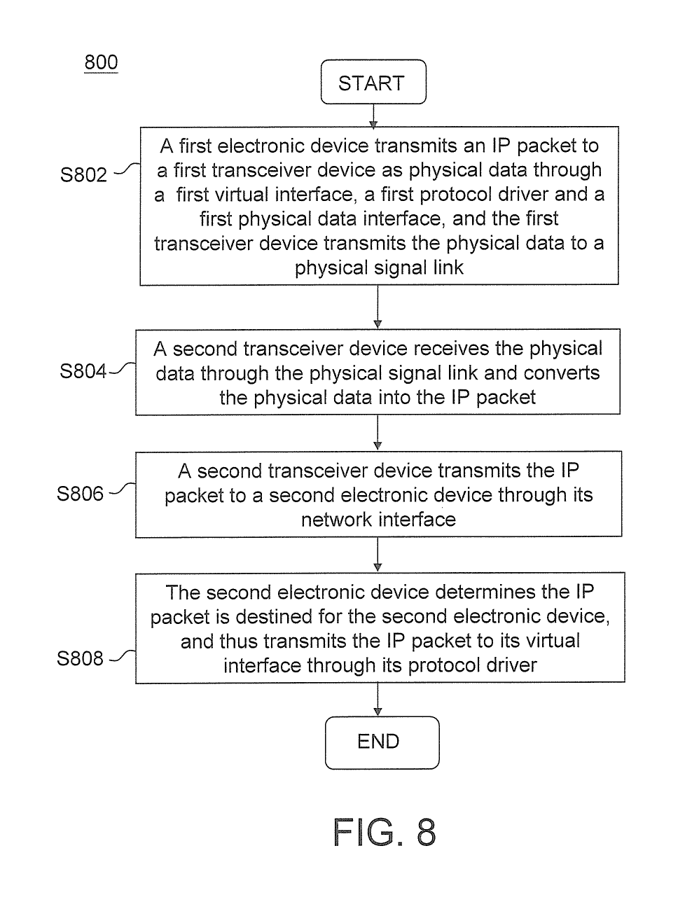

There is also provided a third exemplary embodiment of the invention, in which the architecture of the communication system 300 is similar to that of the communication system 200 except that there is required a virtual interface 411 installed and being operating in the electronic device 240 in the communication system 300 but the electronic device 240 of the communication system 200 does not require the virtual interface 411. The detailed operation procedures for transmitting and receiving IP packet from the electronic device 240 to the electronic device 110 over the transceiver device 120 and the transceiver device 230 in the third exemplary embodiment will be further described in accordance with FIG. 8 to FIG. 10.

FIG. 8 is a flowchart illustrating a method of transmitting an IP packet over a physical signal link without network medium according to a third exemplary embodiment of the invention. Referring to FIG. 2, FIG. 3, FIG. 4 and FIG. 8, the method 800 starts at a step S802. In the step S802, A first electronic device (such as the electronic device 110) transmits an IP packet to a first transceiver device (such as the transceiver device 120) as physical data through a first virtual interface (i.e., the virtual interface 311), a first protocol driver (i.e., the protocol driver 312) and a first physical data interface (i.e., the physical data interface 322). The first transceiver device transmits the physical data to a physical signal link ST. In step S804, a second transceiver device (such as the transceiver device 230) receives the physical data through the physical signal link ST and converts the physical data into the IP packet. In step S806, a second transceiver device transmits the IP packet to a second electronic device (such as the electronic device 240) through its network interface (i.e., the network interface 422). In the step S808, the second electronic device determines the IP packet is destined for the second electronic device, and thus transmits the IP packet to its virtual interface (i.e., the virtual interface 411) through its protocol driver (i.e., the protocol driver 412). The method 800 is terminated after the step S808.

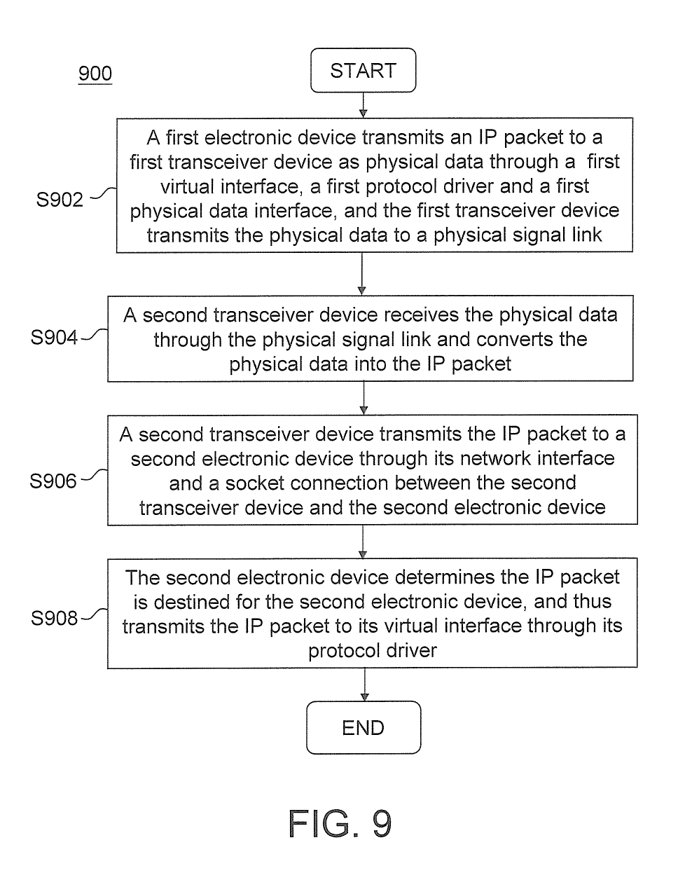

FIG. 9 is a flowchart illustrating another method of transmitting an IP packet over a physical signal link without network medium according to the third exemplary embodiment of the invention. Referring to FIG. 2, FIG. 3, FIG. 4 and FIG. 9, the method 900 starts at a step S902. The step S902 and the step S904 are respectively similar to the step S802 and the step S804, so the detailed procedures are not repeated herein. In step S906, a second transceiver device (such as the transceiver device 230) transmits an IP packet to a second electronic device (such as the electronic device 240) through its network interface and a socket connection SC (as shown in FIG. 2) between the second transceiver device and the second electronic device. In step S908, the second electronic device determines the IP packet is destined for the second electronic device, and thus transmits the IP packet to its virtual interface (i.e., the virtual interface 411) through its protocol driver (i.e., the protocol driver 412). The method 900 is terminated after the step S908.

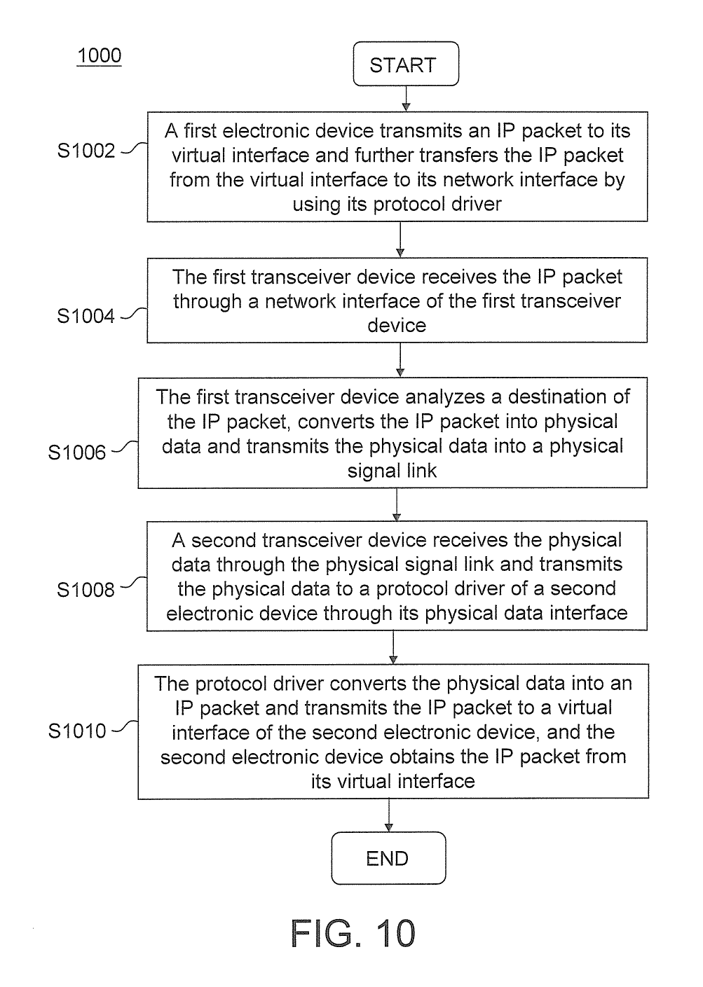

FIG. 10 is a flowchart illustrating a method of receiving an IP packet over a physical signal link without network medium according to the third exemplary embodiment of the invention. Referring to FIG. 2, FIG. 3, FIG. 4 and FIG. 10, the method 1000 starts at a step S1002. The term “receiving” is defined with respect to the electronic device 110. In the step S1002, a first electronic device (such as the electronic device 240) transmits an IP packet to its virtual interface (i.e., the virtual interface 411) and further transfers the IP packet from the virtual interface to its network interface (i.e., the network interface 413) by using its protocol driver (i.e., the protocol driver 412). In step S1004, the first transceiver device (such as the transceiver device 230) receives the IP packet through a network interface (i.e., the network interface 422) of the first transceiver device.

The invention is not limited to the descriptions above, in other embodiments of the invention, similar to the third exemplary embodiment, the first transceiver device (such as the transceiver device 230) can also receive the IP packet through a network interface (i.e., the network interface 422) of the first transceiver device and a socket connection SC (as shown in FIG. 2) between the first transceiver device (i.e., transceiver device 230) and the first electronic device (i.e., the electronic device 240).

Referring to FIG. 10, in step S1006, the first transceiver device analyzes a destination of the IP packet, converts the IP packet into physical data and transmits the physical data into a physical signal link ST. In step S1008, a second transceiver device (such as the transceiver device 120) receives the physical data through the physical signal link ST and transmits the physical data to a protocol driver of a second electronic device (such as the protocol driver 312 of the electronic device 110) through its physical data interface (i.e., the physical data interface 315). In step S1010, the protocol driver (i.e., the protocol driver 312) converts the physical data into an IP packet and transmits the IP packet to a virtual interface (i.e., the virtual interface 311) of the second electronic device, and the second electronic device obtains the IP packet from its virtual interface. The method 1000 is terminated after the step S1010.

In summary, according to the embodiments of the invention, the invention proposes a communication device transmitting and receiving Internet Protocol packet over a physical signal link without network medium and a communication system thereof. The communication device and the communication system realize delivery of IP packet via conventional serial port interface or conventional parallel port interface and physical signal link which are originally designed without a network medium or IP protocol capability. By virtual interface, the communication devices belonging to different IP domain and being separated away can easily achieve delivering IP packet at low cost and high reliability.

It will be apparent to those skilled in the art that various modifications and variations of the exemplary embodiments can be made to the structure of the invention without departing from the scope or spirit of the invention. In view of the foregoing descriptions, it is intended that the present disclosure covers modifications and variations of the exemplary embodiments if they fall within the scope of the following claims and their equivalents.

What is claimed is:

1. A communication device, adapted for transmitting and receiving IP packets over a physical signal link without network medium, comprising:
an electronic device, configured for transmitting a first IP packet and receiving a second IP packet, comprising:
a first physical data interface, configured for transmitting first physical data converted from the first IP packet and receiving second physical data converted from the second IP packet; and
a transceiver device, coupled to the electronic device through the first physical data interface, configured for transmitting the first physical data to the physical signal link and receiving the second physical data from the physical signal link, wherein the transceiver device establishes the physical signal link with the receiver without dialing.

2. The communication device according to claim 1, wherein the electronic device further comprises:
a network interface, configured for providing a network port;
a virtual interface, connected to the network interface, configured for providing an IP domain different from a current IP domain to which the electronic device belongs, and processing the first IP packet and the second IP packet;
a protocol driver, connected to the network interface, the virtual interface and the first physical data interface, configured for capturing the first IP packet from the virtual interface, transmitting the second physical data as the second IP packet to the virtual interface, transmitting the first IP packet as the first physical data through the first physical data interface and receiving the second physical data through the physical data interface.

3. The communication device according to claim 1, wherein the transceiver device comprises:
a second physical data interface, coupled to the first physical data interface, configured for receiving the first physical data from the first physical data interface and transmitting the second physical data to the physical signal link; and
a signal transmission module, connected to the second physical data interface, configured for transmitting the first physical data to the physical signal link and receiving the second physical data from the physical signal link.

4. The communication device according to claim 1, wherein the protocol driver captures the second physical data from the transceiver device, converts the second physical data into the second IP packet and transfers the second IP packet to the virtual interface.

5. The communication device according to claim 1, wherein the electronic device and the transceiver device are integrated as the communication device.

6. The communication device according to claim 1, wherein both the first physical data interface and the second physical data interface are serial port interfaces.

7. The communication device according to claim 1, wherein both the first physical data interface and the second physical data interface are parallel port interfaces.

8. A communication system, adapted for delivering IP packets over a physical signal link without network medium, comprising:
a first communication device, configured for transmitting a first IP packet and receiving a second IP packet, comprising:
a first physical data interface, configured for transmitting first physical data converted from the first IP packet and receiving second physical data which is to be converted to the second IP packet; and
a first transceiver device, coupled to the first physical data interface through a second physical data interface thereof, configured for transmitting the first physical data to the physical signal link and receiving the second physical data from the physical signal link; and
a second communication device, coupled to the first communication device through the physical signal link and the first transceiver device, wherein the first transceiver device establishes the physical signal link with a second transceiver device of the second communication device without dialing.

9. The communication system according to claim 8, wherein the first communication device further comprising:
a first network interface, configured for providing a network port;
a first virtual interface, connected to the first network interface, configured for providing an IP domain different from a current IP domain to which the first communication device belongs, and processing the first IP packet and the second IP packet; and
a first protocol driver, connected to the first network interface, the first virtual interface and the first physical data interface, configured for capturing the first IP packet from the first virtual interface, receiving the second physical data through the first physical data interface transmitting the second physical data as the second IP packet to the first virtual interface and transmitting the first IP packet as the first physical data through the first physical data interface.

10. The communication system according to claim 8, wherein both the first physical data interface and the second physical data interface are serial port interfaces.

11. The communication system according to claim 8, wherein both the first physical data interface and the second physical data interface are parallel port interfaces.

12. The communication system according to claim 8, wherein the second transceiver device comprises a third physical data interface being coupled to a fourth physical data interface of the second communication device.

13. The communication system according to claim 12, wherein both the third physical data interface and the fourth physical data interface are serial port interfaces or parallel port interfaces.

14. The communication system according to claim 8, wherein the second communication device further comprises a second network interface being coupled to a third network interface of the second transceiver device.

15. The communication system according to claim 8, wherein the second communication device further comprises a second network interface being coupled to a third network interface of the second transceiver device.

16. The communication system according to claim 15, wherein the second transceiver device receives the first physical data from the physical signal link, converts the first physical data back to the first IP packet and analyzes a destination of the first IP packet.

17. The communication system according to claim 15, wherein the second transceiver device receives the second IP packet, originated at the second communication device, from the third network interface, analyzes a destination of the second IP packet, converts the second IP packet into the second physical data and transmits the second physical data to the physical signal link.

18. The communication system according to claim 16, wherein the second transceiver device transmits the first IP packet to the second communication device through a socket connection between the second transceiver device and the second communication device, wherein the socket connection is established over the second network interface and the third network interface.

19. The communication system according to claim 16, wherein the second transceiver device receives the second IP packet from the second communication device through a socket connection between the second transceiver device and the second communication device, wherein the socket connection is established over the second network interface and the third network interface.

20. The communication system according to claim 16, wherein the second communication device transmits the second IP packet to a second virtual interface thereof and further transfers the second IP packet from the second virtual interface to the second network interface by using a second protocol driver thereof.
